(19) United States
(12) Patent Application Publication
(10) Pub. No.: US 2024/0186926 A1
(43) Pub. Date: Jun. 6, 2024

(54) Generator Transformer

(71) Applicant: Moise Michel, Pompano Beach, FL (US)

(72) Inventor: Moise Michel, Pompano Beach, FL (US)

(21) Appl. No.: 18/075,898

(22) Filed: Dec. 6, 2022

(51) Int. Cl. H02P 9/38

(52) U.S. Cl. CPC H02P 9/38

(57) ABSTRACT

The generator is the only product of its kind that has the capability of turning a generator head via the power of a drive rather than a motor. The generator is uniquely designed with an advanced sensor technology that sends a signal to the selected outlet of the generator. This unprecedented product is crafted with strong, sturdy materials to ensure sustainability and durability and can be used in a wide variety of settings.

### BACKGROUND

Modern designs of generators require direct motion from a motor to operate the generator head to convert the mechanical energy into electrical energy Generator heads, however, are subject to depreciation and can become quickly damaged should proper maintenance not be performed. This in return creates an inconvenient and costly situation for an individual who seeks to repair the head and/or ensure generator operation. There have been no products available as original equipment or as an aftermarket to address this problem.

An apparatus to generate electricity without the need for frequent replacement of generator heads, saving money and time, is not being met by any known device or system at present. There have been no products available as original equipment or as an aftermarket to address this problem either.

### SUMMARY OF THE INVENTION

The main purpose the generator is to enhance the functionality of the average generator by introducing a drive system that turns the generator head without direct motion.

### BRIEF DESCRIPTION OF THE DRAWINGS

FIG. 1 is a top perspective view of generator in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

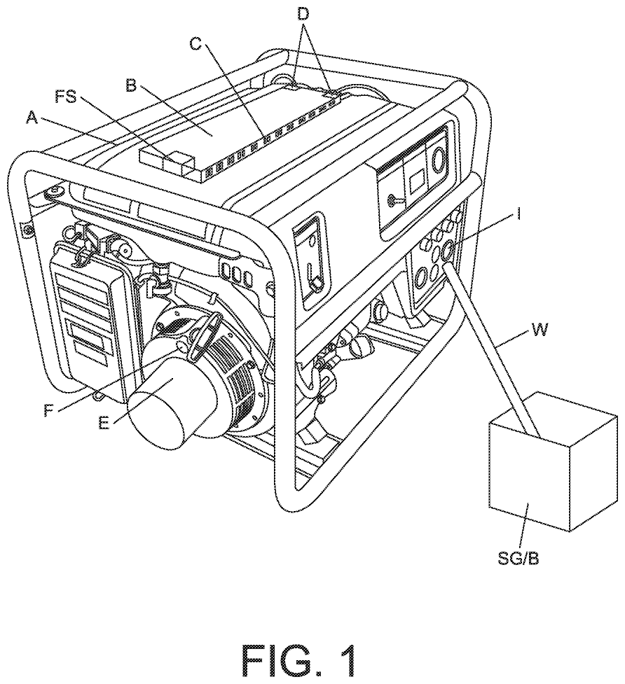

FIG. 1 is a top perspective view of generator showing: generator referenced as A, generator head referenced as B, 120 V outlets/outputs referenced as C, connector that will override one of the generator's outputs referenced as D, shaft referenced as E, sensor (when to send signal to selected outlet of generator) referenced as F, in accordance with an embodiment of the present disclosure. A secondary generator and battery SG/B services the generator at standard electrical inputs thereto via wires W. A failsafe switch FS shuts off the input and/or the output and/or the generator depending on predetermined maximum and minimum operating parameters.

An efficiency of the power output of the generator is limited by a product of the voltage input and amperage input versus a product of the voltage output and the amperage output in embodiments. Additionally, a fail safe switch configured to shut down the variable voltage and variable amperage input based on a versus difference of greater than 10 percent or some other predetermined electrical tolerance. The variable voltage and the variable amperage input also come from a secondary generator and/or battery configured to be electrically and mechanically sympathetic to the variable voltage and variable amperage of the generator.

Ingenious and practical, the generator introduces a novel motor option that eliminates the necessity for direct motion contact to operate the generator but rather utilizes a drive system, electric and otherwise, that enables the generator head to turn on its own. Expanding on the initial design of a generator head output. Once the user selects the output, they can time the rotor on the selected output with a 12v battery and can utilize three (3) wires that support a pick-up sensor. This in return allows for the generator head to activate and turn without direct contact and therefore significantly reduces the likelihood of failure. The generator ensures a fully operational generator at all times and thus this top-quality product can offer a viable alternative to modern designs of generators.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A generator comprising:
a generator head comprising a variable voltage and a variable amperage output based on a variable voltage and a variable amperage input to the generator;
a sensor configured to sense a speed of a rotor of the generator and determine the variable voltage and variable amperage output; and
an electrical connector that overrides one of the generator head's variable voltage and variable amperage outputs.

2. The generator of claim 1, wherein the sensor is in a magnetic field communication with the rotor of the generator.

3. The generator of claim 1, wherein the variable voltage and variable amperage input is supplied from a direct current DC battery.

4. The generator of claim 1, further comprising a direct current battery to store the variable voltage and the variable amperage output.

5. The generator of claim 1, wherein the electrical connector override is a manual selection of one of a predetermined voltage output and amperage output.

6. The generator of claim 1, wherein the sensor is a magnetic pickup sensor disposed on the generator and in communication with the generator head.

7. The generator of claim 1, wherein the electrical connector override determines a timing of the rotor.

8. The generator of claim 1, wherein an external battery voltage and amperage input to the generator head determines a timing of the rotor.

9. The generator of claim 1, further comprising an efficiency of a power output of the generator limited by a product of the voltage input and amperage input versus a product of the voltage output and the amperage output.

10. The generator of claim 9, further comprising a fail safe switch configured to shut down the variable voltage and variable amperage input based on a versus difference of greater than 10 percent.

11. The generator of claim 1, wherein the variable voltage and the variable amperage inputs are standard electrical sockets disposed on the generator.

12. The generator of claim 1, wherein the variable voltage and the variable amperage input come from a secondary generator configured to be sympathetic to the variable voltage and variable amperage of the generator.

13. The generator of claim 1, wherein the variable voltage and the variable amperage input are predetermined based on a 120/240 volt load.

14. The generator of claim 1, wherein the variable voltage and the variable amperage output are predetermined based on a 120/240 volt load.
